(19) United States
(12) Patent Application Publication
(10) Pub. No.: US 2025/0226609 A1
(43) Pub. Date: Jul. 10, 2025

(54) CABLE CONNECTOR SYSTEMS AND METHODS

(71) Applicant: ERICO International Corporation, Solon, OH (US)

(72) Inventor: Michael Hung-Sun Oh, Twinsburg, OH (US)

(21) Appl. No.: 19/008,923

(22) Filed: Jan. 3, 2025

Related U.S. Application Data
(60) Provisional application No. 63/617,618, filed on Jan. 4, 2024.

(51) Int. Cl. H01R 13/50; H01R 43/18

(52) U.S. Cl. CPC H01R 13/50; H01R 43/18

(57) ABSTRACT

A cable connector can include a housing that surrounds an internal passage with first fingers extending away from opposing sides of the housing into the internal passage and a second finger extending away from an interior surface of the housing into the internal passage. The second finger being offset from the first fingers around a perimeter of the internal passage. The first and second fingers partly defining a first opening along the internal passage, as viewed along an insertion direction for a cable through the internal passage. The cable connector can further include an insert that extends within the housing and including a protrusion extending into the internal passage from an opposite side of the internal passage as the second finger, the insert, including the protrusion, defining a second opening along the internal passage, as viewed along the insertion direction.

### CROSS-REFERENCE TO RELATED APPLICATIONS

This application claims the benefit of U.S. Provisional Application No. 63/617,618, filed Jan. 4, 2024, which is hereby incorporated by reference in its entirety.

### BACKGROUND

Cable connectors may be used to secure one or more cables (e.g., armor clad, metal clad, or other cable) to a junction box or other mounting location.

### SUMMARY

Some aspects of the invention provide a cable connector for securing a cable. The cable connector can include a housing that surrounds an internal passage with first fingers extending away from opposing sides of the housing into the internal passage and a second finger extending away from an interior surface of the housing into the internal passage. The second finger being offset from the first fingers around a perimeter of the internal passage. The first and second fingers partly defining a first opening along the internal passage, as viewed along an insertion direction for a cable through the internal passage. The cable connector can further include an insert that extends within the housing and including a protrusion extending into the internal passage from an opposite side of the internal passage as the second finger, the insert, including the protrusion, defining a second opening along the internal passage, as viewed along the insertion direction. The first opening defined by the first fingers and the second finger being axially offset from the second opening defined by the insert, along a longitudinal axis of the cable connector to receive conductors.

Some aspects of the invention provide a method of making a cable connector. The method can include providing a single-piece blank, bending fingers defined by the blank out of a plane defined by the blank so that the fingers extends at acute angles relative to the plane defined by the piece of material, arranging a dovetail protrusion within a dovetail slot of the blank by bending the blank along a series of slots formed in the blank to form a housing with an internal passage, the fingers protruding into the internal passage.

Some aspects of the invention provide a cable connector for securing a cable. The cable connector can include a housing that defines an internal passage with an insertion direction for installing a cable through the internal passage. The housing can integrally include side walls that surround the internal passage along the insertion direction and a set of fingers including first fingers and a second finger extending resiliently into the internal passage to define, in cooperation with a side wall of the housing, a first opening to receive and capture cable within the internal passage, and an insert secured to the housing and protruding into the internal passage to define a second opening, axially offset from the first opening. The housing can have an installed configuration in which the housing is secured at a knockout of a junction box, the cable is secured within the first opening by the set of fingers and the side wall, and the cable extends through the second opening insert into the junction box.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a cable connector according to aspects of the present disclosure.

FIG. 2 is a first end view of the cable connector of FIG. 1.

FIG. 3 is a second end view of the cable connector of FIG. 1.

FIG. 4 is a cross-sectional view of the cable connector of FIG. 1.

FIG. 5 is a cross-sectional view of the cable connector of FIG. 1 disassembled.

FIG. 6 is a cross-sectional view of the cable connector of FIG. 5 assembled.

FIG. 7 is a top view of a formed blank for a housing of the cable connector of FIG. 1

FIG. 8 is a top view of the housing of after further forming of the blank of FIG. 7.

FIG. 9 is a first axonometric view of the housing of the cable connector of FIG. 1.

FIG. 10 is a second axonometric view of the housing of FIG. 9.

FIG. 11 is a first axonometric view of an insert of the cable connector of FIG. 1.

FIG. 12 is a second axonometric view of the insert of FIG. 11.

FIG. 13 is a cross-sectional view of the insert of FIG. 11.

FIG. 14 is an axonometric view of a cable connection assembly using the cable connector of FIG. 1.

FIG. 15A is a first end view of the cable connection assembly of FIG. 14 with a cable installed.

FIG. 15B is a first end view of the cable connection assembly of FIG. 14 with another cable installed.

FIG. 15C is a first end view of the cable connection assembly of FIG. 14 with yet another cable installed.

FIG. 16 is a second end view of the cable connector of FIG. 1 without a cable installed.

FIG. 17 is a cross-sectional view of the cable connector of FIG. 1 with a cable installed.

FIG. 18 is an axonometric view of another example of a cable connector according to aspects of the present disclosure.

FIG. 19 is a first end view of the cable connector of FIG. 18.

FIG. 20 is a second end view of the cable connector of FIG. 18.

FIG. 21 is a cross-sectional view of the cable connector of FIG. 18.

FIG. 22 is a cross-sectional view of the cable connector of FIG. 18 disassembled.

FIG. 23 is a cross-sectional view of the cable connector of FIG. 18 assembled.

FIG. 24 is an axonometric view of the cable connector of FIG. 18.

FIG. 25 is a top view of a formed blank for a housing of the cable connector of FIG. 18

FIG. 26 is a top view of the housing of after further forming of the blank of FIG. 25.

FIG. 27 is a first axonometric view of the housing of the cable connector of FIG. 18.

FIG. 28 is a second axonometric view of the housing of FIG. 27.

FIG. 29 is a first axonometric view of an insert of the cable connector of FIG. 18.

FIG. 30 is a second axonometric view of the insert of FIG. 29.

FIG. 31 is a third axonometric view of the insert of FIG. 29.

FIG. 32 is a cross-sectional view of the insert of FIG. 29.

FIG. 33 is an axonometric view of a cable connection assembly using the cable connector of FIG. 18.

FIG. 34A is a first end view of the cable connection assembly of FIG. 33 with a cable installed.

FIG. 34B is a first end view of the cable connection assembly of FIG. 33 with another cable installed.

FIG. 35 is a second end view of the cable connector of FIG. 18 without a cable installed.

FIG. 36 is a cross-sectional view of the cable connector of FIG. 18 with a cable installed.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Conventional cable connectors include a three-piece assembly including a zinc die-cast housing, a spring steel retention member, and a plastic insulator. This configuration can increase expenses and complications for the manufacturing process. Additionally, many current cable connectors may have minimal contact between the cable and the housing, which may cause the connectors to struggle during high current loads. Further, the retention member typically include stiff retention arms configured to retain the cable, in some cases with sharp ends that may damage the cable during insertion of the cable into the cable connector.

As generally noted above, it may be beneficial to reduce the complexity involved in the manufacture of a cable connector. Further, it may be beneficial to reduce the risk of damage to conductors (e.g., wires) during use of the cable connector. In one example, a cable connector may include a two-piece assembly including a housing and an insert that extends into and is secured to the housing. For example, an insert can help to guide insertion and retention of a cable with an alignment, and the housing can support the insert and the cable relative to a wall of a junction box.

To help secure cables, a housing can include a plurality of fingers that can extend to resiliently engage cable inserted through the housing (e.g., extending integrally from side walls of the housing) In one example, the housing may include four (4) resilient fingers configured to retain the exterior sheath of a cable to secure the cable within the connector, with each finger engaging the cable from a respective one of four sides (e.g., with each finger as a biased, cantilevered tab extending from a corresponding side wall of the housing). In other examples, the housing may include three (3) fingers, with the exterior sheath of the cable arranged between the fingers and a sidewall of the housing (e.g., clamped against the housing), which may increase the current capacity of the connector. Further, in some examples, a finger arranged opposite the side wall of the housing may be double the thickness of the other fingers, which may provide an increased clamping force to retain the cable.

In some cases, fingers may be axially offset relative to each other, so that a free end of any given finger engages a cable at a different axial position along the cable than does a free end of any adjacent (or any other) finger. For example, the connector may include at least three (3) axially offset fingers connected at one end to the housing and extending away from the housing at an acute angle, with each of the fingers extending to engage a cable at a different axial position.

In some examples, free ends of fingers to engage cables can be shaped to provide improved engagement. For example, free ends of retention fingers may be angled or butterfly shaped (i.e., include two curved protrusions), without sharp edges, to reduce the risk of damage to conductors.

To help guide and otherwise align cables during installation, without adversely impeding the passage of wires or other conductors, an insert can include inwardly extending protrusions. In some examples, the insert may include four (4) protrusions extending from an interior surface of the insert to prevent the exterior sheath of the cable from passing through an opening defined by the insert. However, in other examples, the insert may include only a single protrusion extending from an interior surface of the insert and arranged opposite the double thickness finger, on the same side as the side wall of the housing. In some examples, inwardly extending protrusions on an insert may include angled surfaces to permit the use of a variety of cable sizes with only a single connector size. In one example, the insert may include a beveled mouth opening to facilitate ease of insertion of the cable into the connector (e.g., guide cable into the insert). In other examples, the protrusion may include a flat portion facing towards the fingers to abut the exterior sheath of the cable during insertion of the cable.

As mentioned above, a two-piece connector assembly may include a housing and an insert. In one example, the insert may be snap-fit into the housing. For example, the housing may include one or more biased arms, which can lock into corresponding cutouts on the insert to secure the insert into the housing as a unitary connector assembly. In other examples, as the cable is clamped against the side wall of the housing, the side of the housing clamping the cable may be flat, with a pair of tabs on the insert arranged through corresponding openings in the side wall of the housing in order to secure the insert to the housing.

In some example manufacturing approaches, a housing may be assembled from a sheet of metal (or other material) by first bending fingers away from a substrate plane of the material and then further bending the sheet of material into the desired shape of the housing (e.g., a rectangular tube). In some examples, one or more dovetails joints can be formed and then staked prior to heat treating.

In one particular example, to facilitate ease of insertion of the cable into the connector, an opening defined by fingers of a housing and an opening defined by protrusions of an insert may be coaxial, such that the cable may be inserted into the connector without the need to bend or deform the cable. However, in other examples, to provide increased pull out resistance, the opening defined by fingers of the housing and the opening defined by the protrusion of the insert may be parallel, but offset.

In some examples, once a connector is inserted into a knockout of a junction box or other mounting location, connection structures on the connector may mitigate wobble between the connector and the knockout. For example, some housing configurations according to the disclosed technology can include wings, protrusions, or other features to provide improved contact between the connector and material that surrounds a knockout. For example, the connector may contact a junction box at a knockout with at least ten (10) or twelve (12) points of contact. For example, with six (6) points of contact between a pair of opposing locking tabs and four (4) or six (6) points of contact between a pair of opposing retention tabs.

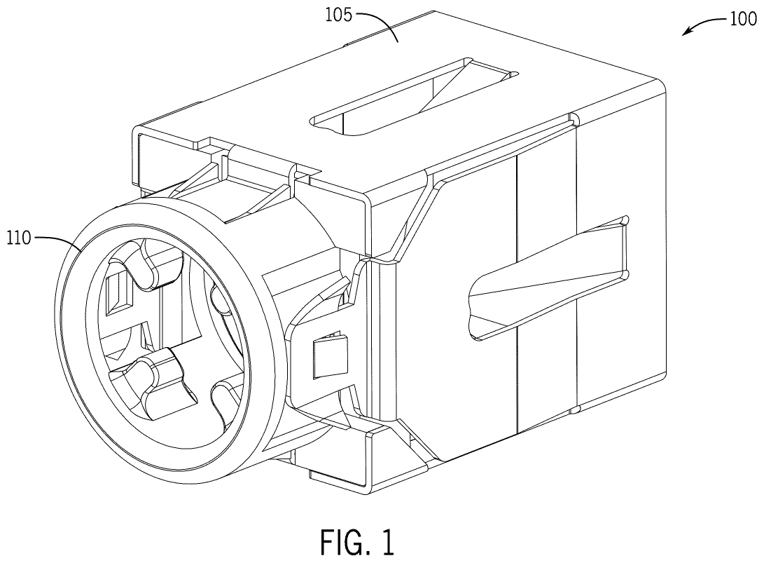

FIGS. 1-4 illustrate an example of a connector 100 for retaining a cable (e.g., a metal clad cable, armor clad cable, wire, etc.). In one example, the connector 100 may include a housing 105 that receives an insert 110. In one example, the housing 105 may define a rectangular shape, while the insert 110 may define a circular shape, at least at one end thereof. For example, the insert 110 may define a circular shape to permit a user to secure the connector 100 within a circular knockout of a junction box or other mounting location, whereas the housing 105 may define a rectangular shape for improved manufacturability and overall assembly performance. As should be appreciated, the dimensions of the insert 110—and the connector 100 generally—may be sized match a particular size knockout on the junction box (e.g., a ½ inch knockout, ¾ inch knockout, etc.). In other examples, the housing 105 may define other shapes other than rectangular (e.g., circular, polygonal, etc.). In one particular example, the housing 105 may be made from a metal material, while the insert 110 may be made from a plastic or other polymeric material.

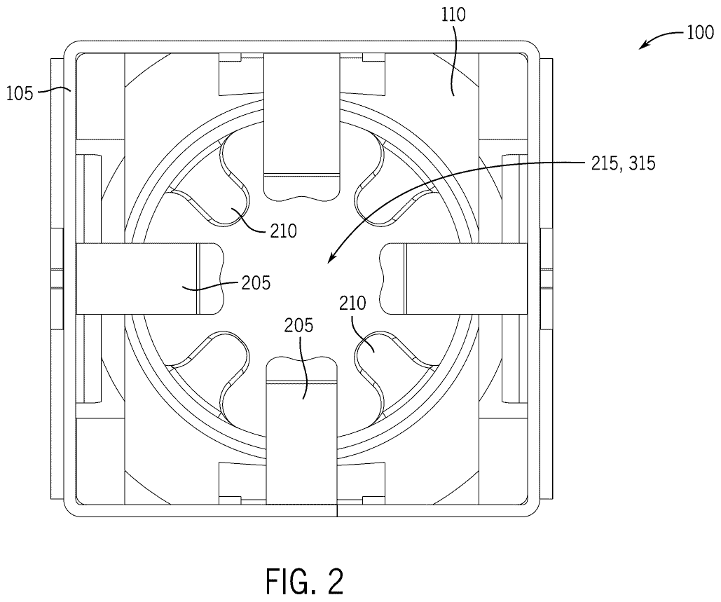

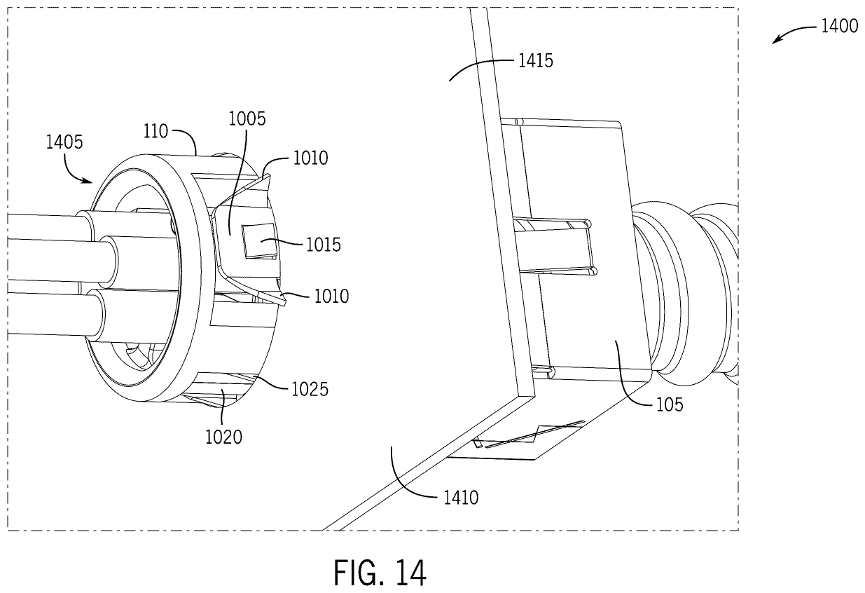

Referring to FIG. 2 in particular, the connector 100 may be configured to receive and retain a cable within a passage through the connector 100 (cable not shown in FIG. 2; see, e.g., FIGS. 14, 15, and 17). In one particular example, the connector 100 may be configured to retain armor clad or metal clad cable having an exterior sheath surrounding one or more interior conductors (e.g., wires). In one particular example, the exterior sheath of the cable may define a series of spiral grooves around the exterior circumference of the cable (see also FIGS. 14, 15, and 17).

To secure the cable within the passage through the connector 100, the housing 105 may include one or more fingers 205 that can be arranged with offset spacing around a perimeter of the internal passage of the connector 100 to define an opening 215 for a cable, with the opening 215 defining a reduced cross-sectional area relative to the full passage through the connector 100 (as viewed along an insertion direction through the internal passage—e.g., into the page in FIG. 2). In one particular example, the fingers 205 may be biased towards engagement with the cable to secure the cable within the opening 215. However, the fingers 205 may also exhibit sufficient flexibility so that the cable may be inserted into the opening 215 without excessive force or risk of damaging the cable. To further improve retentive engagement and reduce the risk of damage to the cable, the fingers 205 may include an edge 305 defining a butterfly type shape, without sharp edges or corners.

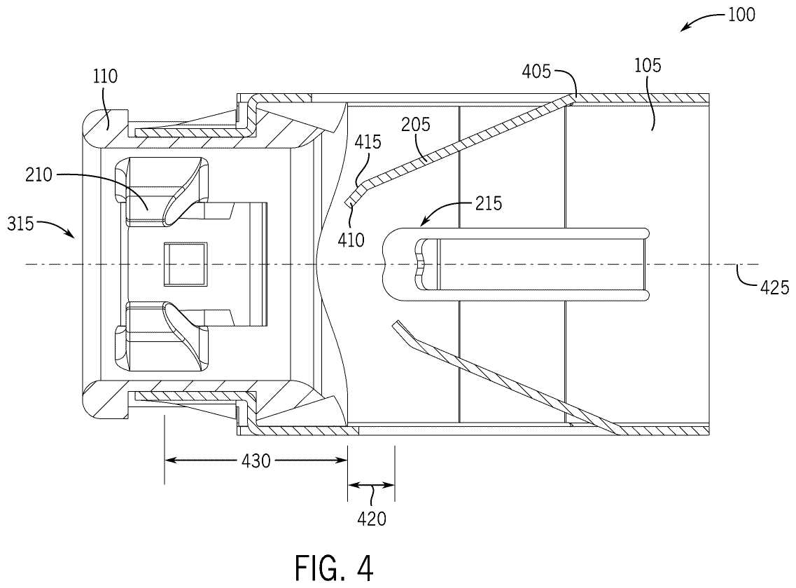

Referring in particular to FIG. 4, the fingers 205 may have, respectively, a first end 405 secured to the housing 105 and may extend from the first end 405 away from the housing 105 at an acute angle toward a second end 410. In one example, the second end 410 may define an angled portion 415 to further support appropriate positioning and engagement of the second end 410 within the groove of the exterior sheath of a cable (e.g., to “lock” into the groove of the cable). As mentioned previously, the fingers 205 may be biased towards the cable so that, when the cable is inserted (axially) into the connector 100, the fingers 205 apply a retention force to the cable.

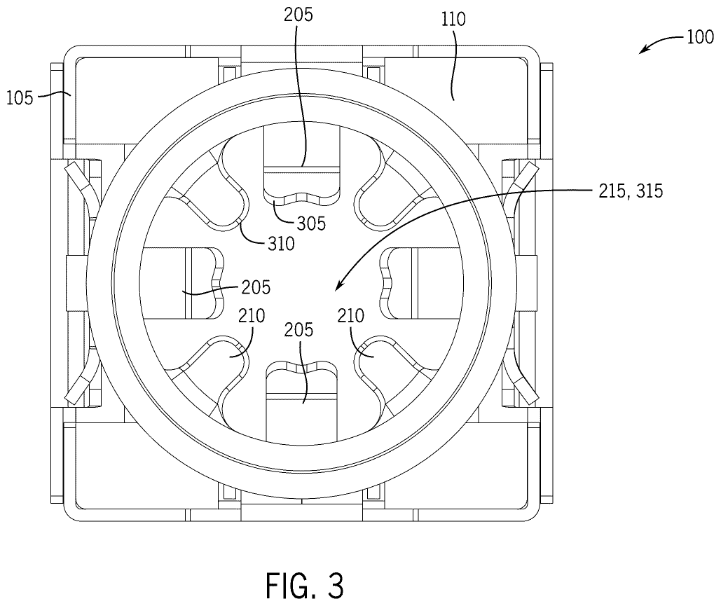

The insert 110 may also define an opening 315 to axially receive a cable. Complementary to the fingers 205, the insert 110 may include one or more protrusions 210 that can define a reduced cross-sectional area of the opening 315. In this regard, for example, the protrusions 210 can help to prevent over-insertion of the exterior sheath of the cable, while guiding the conductors of the cable through the connector 100. The protrusions 210 may include a rounded inner edge 310 (see FIG. 3) to reduce the risk of damage to the conductors when the conductors pass through the opening 315 of the connector 100. In one particular example, the connector 100 may include four (4) protrusions 210. In one example, the protrusions 210 may be offset from the fingers 205 by about 45 degrees around a perimeter of the internal passage of the connector 100 (see, e.g., FIG. 2) or otherwise arranged in a circumferentially alternating arrangement with the fingers 205, as viewed from an axial perspective.

To facilitate insertion of the cable into the connector 100, one or both of the openings 215, 315 may be entered on a longitudinal axis 425 of the connector 100. In general, the openings 215, 315 defined by the protrusions 210 and the fingers 205 may be coaxially aligned on the axis 425 so that a user may insert the cable into the connector 100 along the axis 425. This can allow users to avoid the need to bend the cable within the connector 100, which can increase the difficulty of inserting the cable within the connector 100.

In one example, the fingers 205 may longitudinally offset relative to each other along the axis 425 (e.g., as shown by offset 420 in FIG. 4). In some cases, the offset 420 may correspond to a pitch of a spiral exterior of a cable, so that each of the fingers 205 can seat in a trough portion of the spiral. In some examples, a distance 430 from the protrusions 210 to one of the fingers 205 may be configured to permit at least two spiral grooves of an exterior sheath of the cable to be arranged between the fingers 205 and the protrusions 210. Thus, even if the fingers 205 were to slip off of one of the grooves of the exterior sheath of the cable, the fingers may grab or grip another groove of the cable. In another example, the two spiral groove spacing may mitigate the risk of tearing of the exterior sheath of the cable when a pull-out force is applied to the cable.

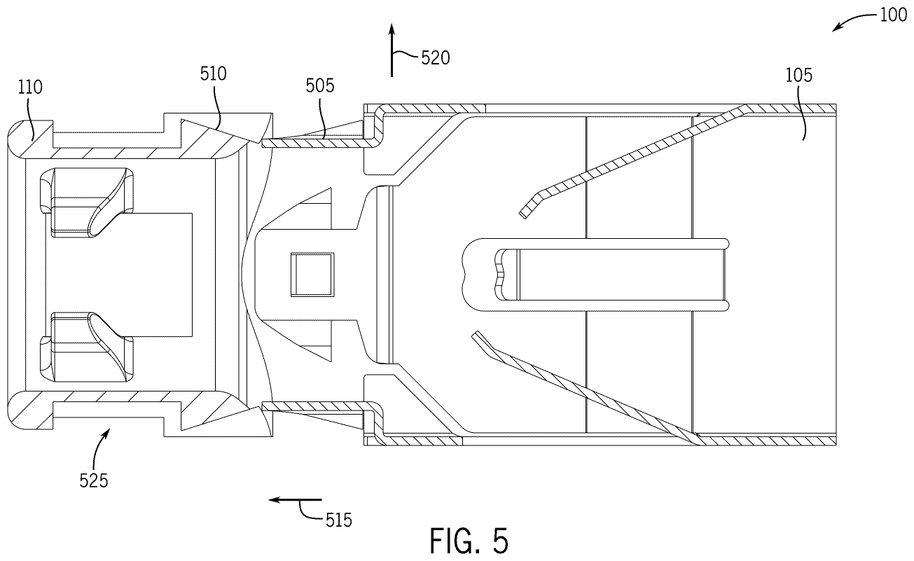

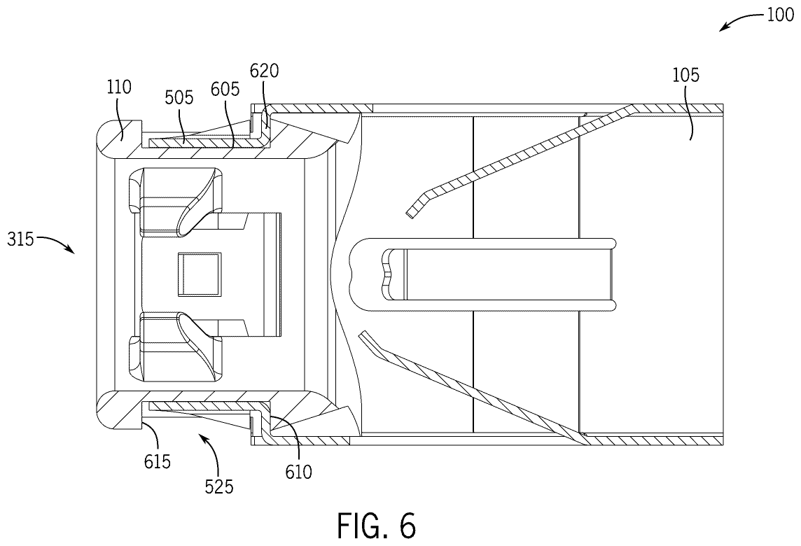

FIGS. 5 and 6 show an example of a snap-fit assembly method for the connector 100. For example, to secure the insert 110 to the housing 105 (e.g., to form the connector 100), one or more arms 505 of the housing 105 may be aligned with one or more ramped surfaces 510 of the connector 100 (e.g., exterior ramped surfaces, as shown). Following this, a user may push the housing 105 towards the insert 110 as shown by arrow 515 (or push the housing 105 towards the insert 110), to cause the biased arms 505 to deflect outwards along the ramped surface 510 (e.g., in a direction shown by arrow 520). The user may then continue to push the housing 105 and the insert 110 together until the arms 505 snap (or otherwise lock) into a cutout 525. With this arrangement, as shown in FIG. 6, the insert 110 can be securely attached to the housing 105 to provide a guide and stop for cables (as further discussed above and below), without extending internal to the housing 105 so as to impede insertion of cables of various sizes.

In some examples, the cutouts 525 can be arranged circumferentially around the insert 110. For example, looking at FIG. 6, the cutout 525 may be defined by a first wall 610 and a second wall 615 with an inner surface 605 extending between the first wall 610 and the second wall 615. Thus, when the arms 505 lock into the cutout 525, the arms 505 contact the inner surface 605 so that a base 620 of the arms 505 contacts the first wall 610 of the cutout 525 to prevent removal of the housing 105 from the insert 110. Further, the second wall 615 can provide a stop against over-insertion of the insert 110 into the housing 105. Thus, for example, the arms 505 and the base 620 are retained within the cutout 525 via the first wall 610 and the second wall 615. In one example, after securing the insert 110 into the housing 105, the insert 110 and the housing 105 form a unitary assembly in the form of the connector 100.

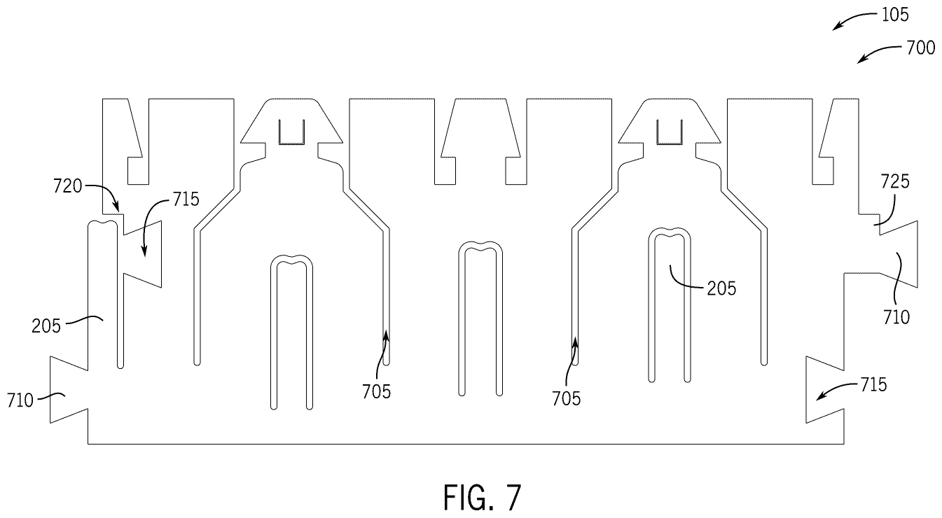

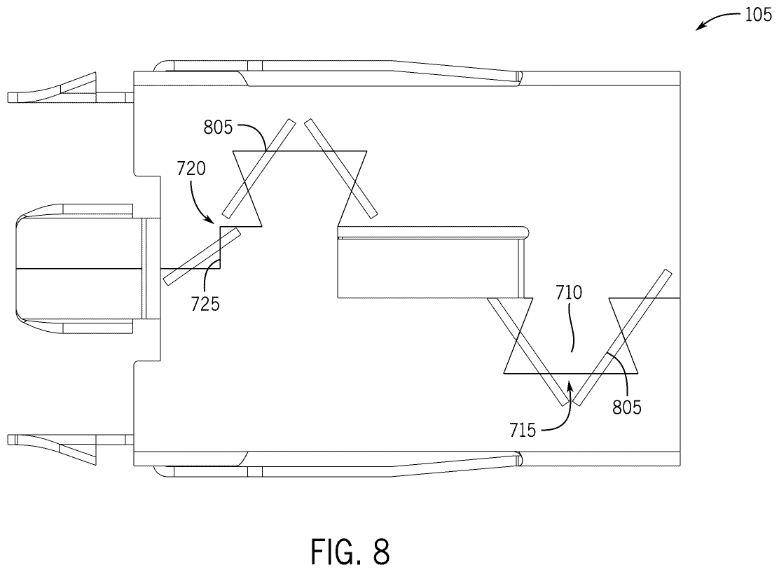

An assembly process for the housing 105 will be discussed with respect to FIGS. 7 and 8, for example, the housing 105 may begin as a blank of metal, blank 700 (e.g., spring steel having a thickness of about 0.024 inch). In an initial (e.g., initially stamped) form, as shown in FIG. 7, the blank 700 may include a series of slots 705 corresponding to bend locations at which the blank 700 can be bent to form the final shape of the housing 105. In one example, once the blank 700 is bent to form the housing 105 shape, one or more dovetail protrusions 710 may be located within one or more dovetail slots 715.

In one example, prior to bending the blank 700 into a rectangular or other final shape for the housing 105, the fingers 205 are first bent away from the blank 700. Such an approach, for example, can permit formation and processing of dovetail features, particularly relative to the right-side dovetail protrusion 710 of FIG. 7 and the corresponding left-side dovetail slot 715. In a particular example, in this regard, the blank 700 may include a notch 720 located adjacent one of the dovetail slots 715 to preserve sufficient material and clearance for formation of the corresponding finger 205 (e.g., the left-most finger 205 in FIG. 7). Correspondingly, the dovetail protrusion 710 may include a plug 725 that offsets the protrusion away from a main body of the blank 700 and can be folded to fill in the notch 720 (see also FIG. 8).

Once the blank 700 has been folded along the slots 705 to form the shape of the housing 105, prior to heat treating the housing 105, the operator may stake 805 the connections between the dovetail protrusions 710 and the dovetail slots 715. In one example, once the dovetail protrusions 710 and the dovetail slots 715 are staked 805 together, the housing 105 may undergo a heat treat process to harden the housing 105.

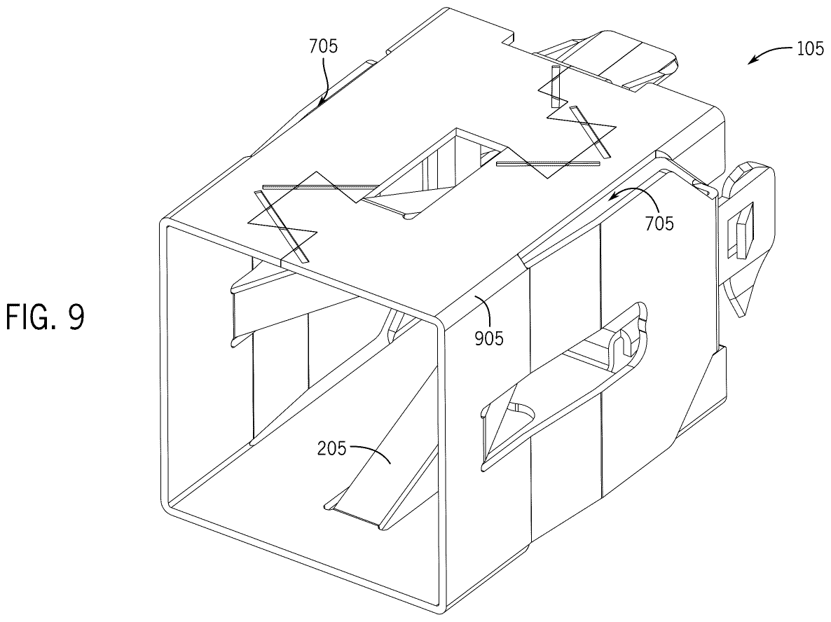

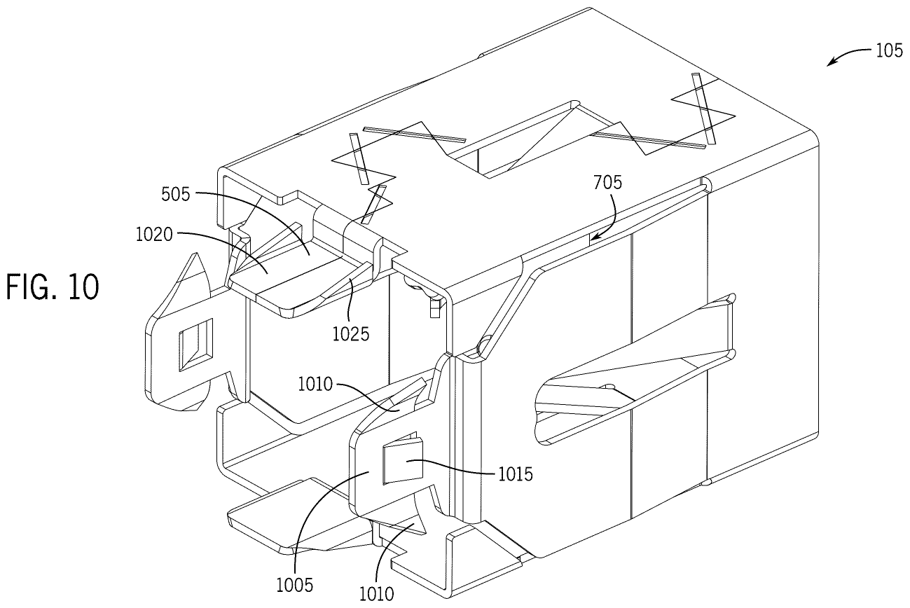

Looking now at FIGS. 9 and 10, the assembled housing 105 is shown. As mentioned previously, the housing 105 includes slots 705 at each of the corners or bends 905 of the housing 105. Thus, each side of the housing 105 may be at least partially cantilevered, and correspondingly flexible to permit some deflection in the sides of the housing 105. For example, the slides of the housing 105 may be deflected during insertion of one or more locking tabs 1005 into a knockout of a mounting location (as further discussed below).

In one example, referring in particular to FIG. 10, the locking tabs 1005 may include a pair of wings 1010 and a locking protrusion 1015 (e.g., centered or otherwise between the wings 1010) configured to engage the knockout to secure the connector 100 within the knockout (e.g., via snap or interference fit). The housing 105 may further include one or more retention tabs 1020 configured to further secure the housing 105 within the knockout (e.g., in the illustrated example, formed on the arms 505). For example, the retention tabs 1020 may include an angled surface 1025 configured to wedge the connector 100 within the knockout. In one example, the angled surface 1025 may permit a user to wedge or fit the connector 100 within knockouts of having slight variations from standard opening sizes, with corresponding improvements in prevention of wobble between the connector 100 and the junction box or other mounting location. In one particular example, the locking tabs 1005 may be arranged on two (2) sides of the housing 105, opposite each other. Correspondingly, the retention tabs 1020 may be arranged on two (2) sides of the housing 105, opposite each other.

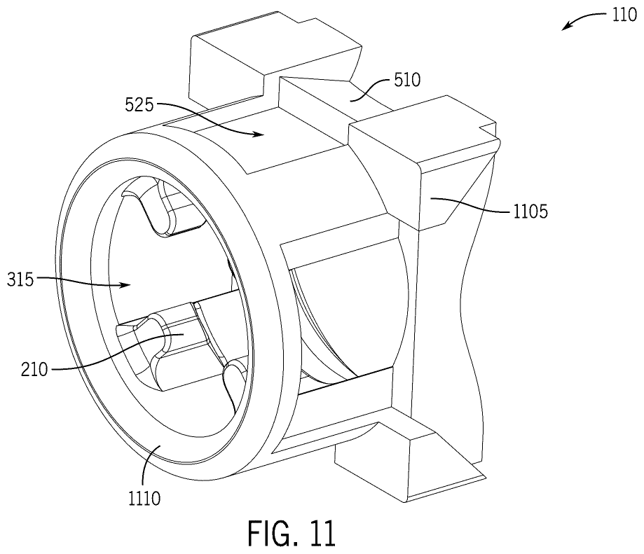

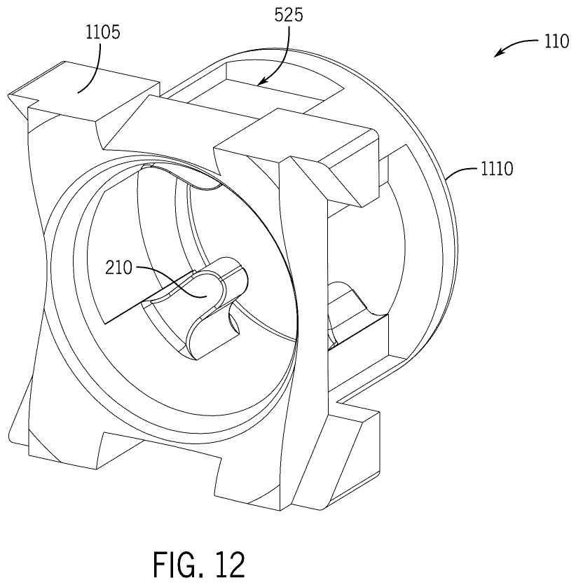

FIGS. 11-13 show an example of the insert 110 of the connector 100. In one example, the insert 110 may include a base 1105 and a flange 1110 extending away from the base 1105. The base 1105 may define a substantially rectangular shape to permit the insert 110 to fit within the housing 105. Put differently, the shape of the base 1105 may correspond to the shape of the housing 105. In one example, the flange 1110 may define a substantially circular (or cylindrical) shape to permit the insert 110 to fit within the knockout of the junction box or other mounting location. As mentioned previously, the flange 1110 may be sized to correspond to (e.g., have a diameter approximately equal to) a predetermined knockout size (e.g., ½ inch, ¾ inch, etc.).

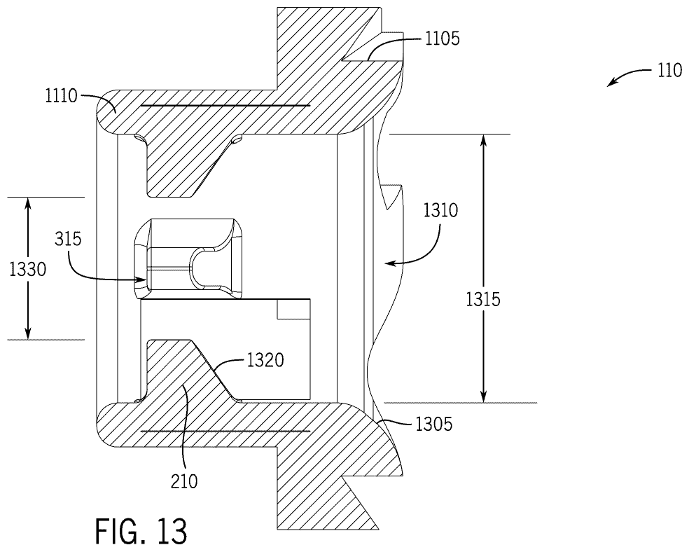

In one example, referring particularly to FIG. 13, the insert 110 may include a beveled edge 1305 forming a mouth 1310. The mouth 1310 may include a diameter 1315 that is larger than a corresponding diameter 1330 of the opening 315 defined by the protrusions 210. For example, the diameter 1315 of the mouth 1310 may be larger to permit a user to insert the cable (including the exterior sheath) into the insert 110 until an axial end of the exterior sheath contacts an angled surface 1320 of the protrusions 210. In other words, the mouth 1310 can provide a relatively large diameter entrance to receive a cable into the insert 110, and the protrusions 210 can define a smaller diameter cross-section at the opening 315 to provide a stop for a cable sheath while still allowing passage of conductors within a cable.

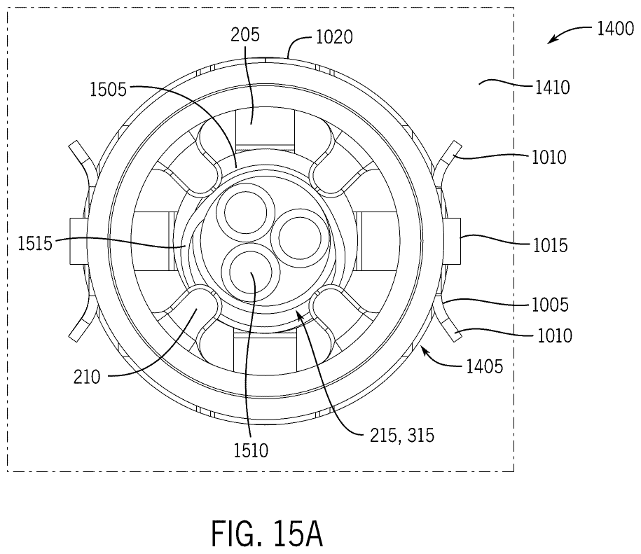

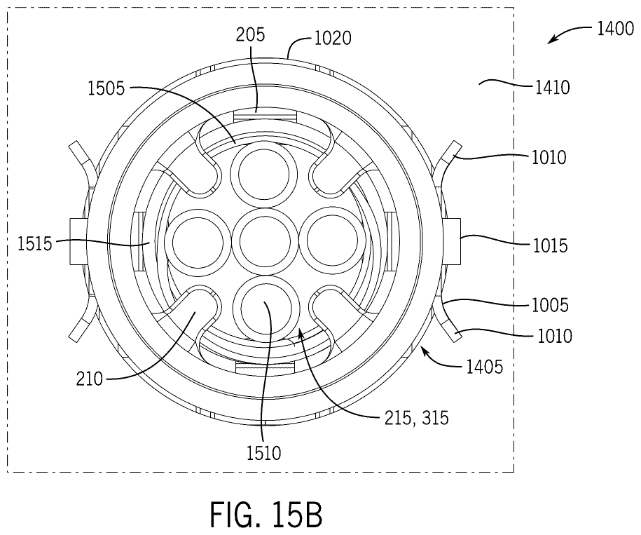

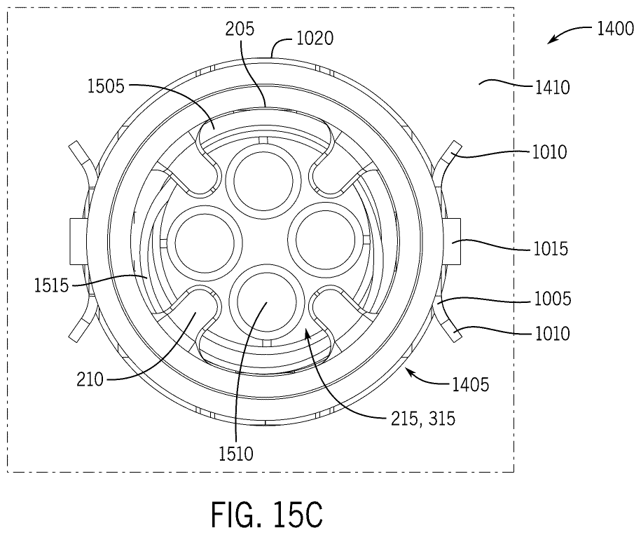

In one example, based on the size (e.g., diameter) of the cable, the exterior sheath may contact the protrusions 210 at different points along the protrusions 210. Thus, for example, the protrusions 210 can permit a single size of the connector 100 (or the insert 110) to be used with various sizes of cable. In one example, after the exterior sheath of the cable contacts the protrusions 210, the conductors (e.g., wires) may extend through the opening 315 of the insert 110, with the exterior sheath of the cable prevented from passing through the opening 315 via the protrusions 210 (see, e.g., FIGS. 14 and 15).

In one example, the beveled edge 1305 of the mouth 1310 funnels the cable through the insert 110 for ease of insertion of the cable. In one particular example, the size of the diameter 1315 may be 0.64 inch and the size of the diameter 1330 may be 0.34 inch for a ½ inch knockout, which may permit the use of 14-2, 14-3, 14-4, 12-2, 12-3, 12-4, 10-2, and 10-3 metal clad or armor clad cable. In another example, the size of the diameter 1315 may be 0.82 inch and the size of the diameter 1330 may be 0.58 inch for a ¾ inch knockout, which may permit the use of 12-4, 10-2, 10-3, 10-4, 8-2, 8-3, and 8-4 metal clad or armor clad cable.

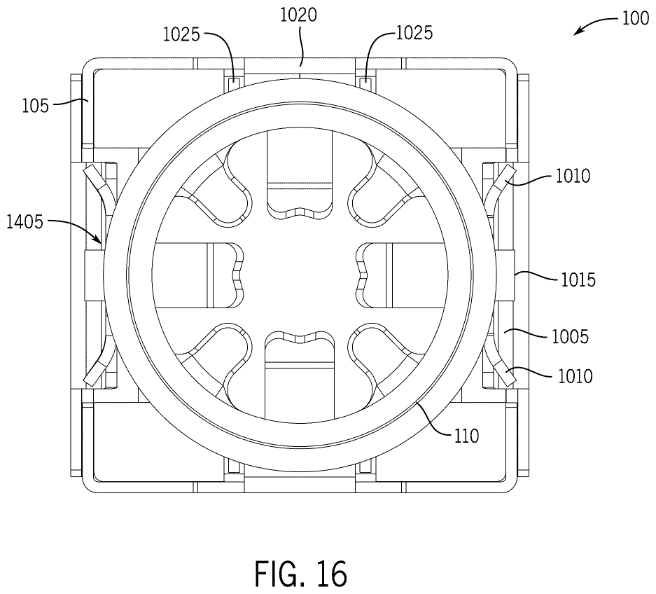

FIGS. 14-17 show examples of a cable connection assembly 1400 with the connector 100 secured within a knockout 1405 of a mounting location 1410 (e.g., a wall of a junction box) and with a cable 1505 (e.g., a metal clad or armor clad cable) arranged within the openings 215, 315 of the connector 100 (see FIGS. 15A-15C in particular). In one example, the wings 1010 and the locking protrusion 1015 of the locking tabs 1005 may protrude through the knockout 1405 and engage the surface 1415 of the mounting location 1410 to prevent removal of the connector 100 from the mounting location 1410. Further, to tighten the connection between the connector 100 and the knockout 1405 (e.g., take-up tolerance between the connector 100 and the knockout 1405) the angled surface 1025 of the retention tabs 1020 may wedge the connector 100 into the knockout 1405. Thus, the further the connector 100 is pushed into the knockout 1405 the more strongly the tabs 1020 will engage the surrounding material, due to the angled surface 1025 of the retention tabs 1020. In one example, when the connector 100 is inserted into the knockout 1405, the connector 100 may have ten (10) points of contact between the connector 100 and the surface 1415 of the mounting location 1410 to mitigate wobble between the connector and the knockout (e.g., via the retention tabs 1020 and the locking tabs 1005, collectively).

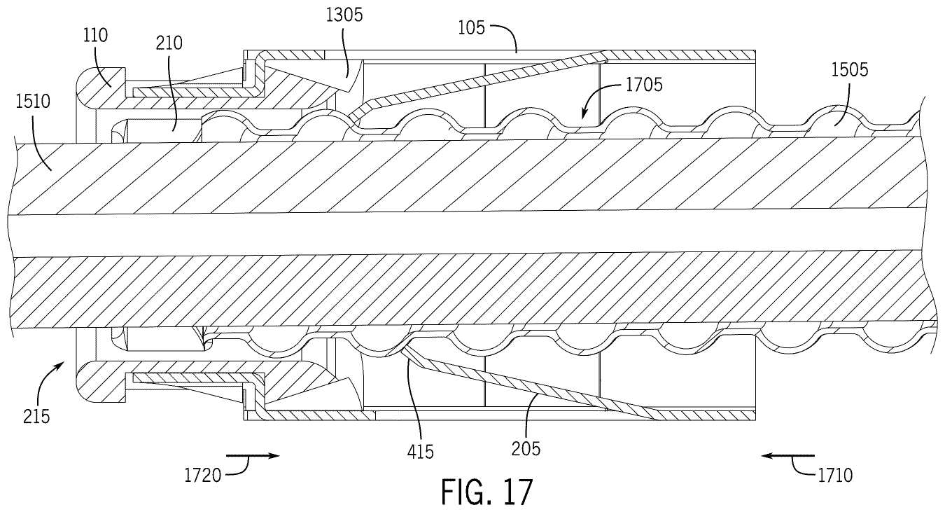

In one example, once the connector 100 is secured within the knockout 1405, the cable 1505 may be inserted into the connector 100. As shown, the cable 1505 may include an exterior sheath 1515 (e.g., metal or armor cladding), which defines a spiral groove 1705. In one example, the cable 1505 may include one or more conductors 1510 (e.g., insulated wires) arranged within the exterior sheath 1515 (see, e.g., FIGS. 15A-15C in particular). As discussed previously, the fingers 205 may lock within the spiral groove 1705 of exterior sheath 1515. In one particular example, the angled portion 415 of the fingers 205 may be arranged to lock into a corner of the groove 1705 to secure the cable 1505 within the connector 100 (see FIG. 17).

Still referring to FIG. 17, in one example, to insert the cable 1505, the cable 1505 may be pushed into the opening 215 of the connector 100 in the direction shown by arrow 1710. The resulting movement of the cable 1505 can deflect the fingers 205 away from the exterior sheath 1515, until a front edge of the exterior sheath 1515 contacts the protrusions 210. In one example, based on the overall size (e.g., diameter) of the exterior sheath, the exterior sheath 1515 may contact the protrusions 210 at different locations (see, e.g., FIGS. 15A-15C). Put differently, the exterior sheath 1515 may take up a larger amount of the openings 215, 315 for a larger cable size (see, e.g., FIG. 15C) and may take up a smaller amount of the openings 215, 315 for a smaller cable size (see, e.g., FIG. 15A).

Once the exterior sheath 1515 contacts the protrusions 210, the one or more fingers 205 may engage with the groove 1705 of the exterior sheath 1515 to lock the cable 1505 within the connector 100. Correspondingly, the cable 1505 may be prevented from movement in the direction shown by arrow 1720 (e.g., via the fingers 205). Further, due to the difference in size between the exterior sheath 1515 and the conductors 1510, the exterior sheath 1515 is prevented from protruding through the opening 315 via the protrusions 210 while the conductors 1510 can protrude through the opening 315 into the junction box or other location (e.g., through the knockout 1405 as shown in FIG. 14).

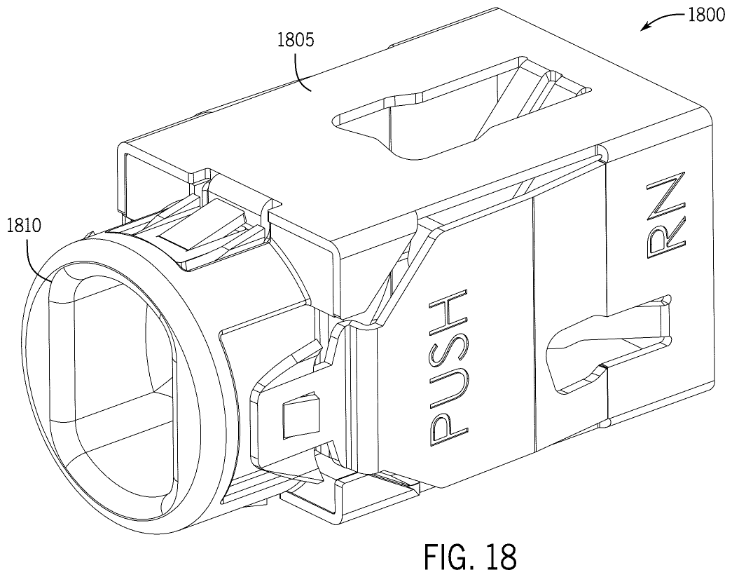

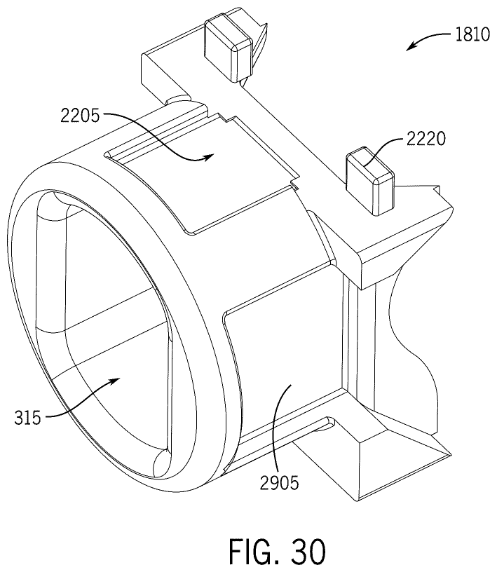

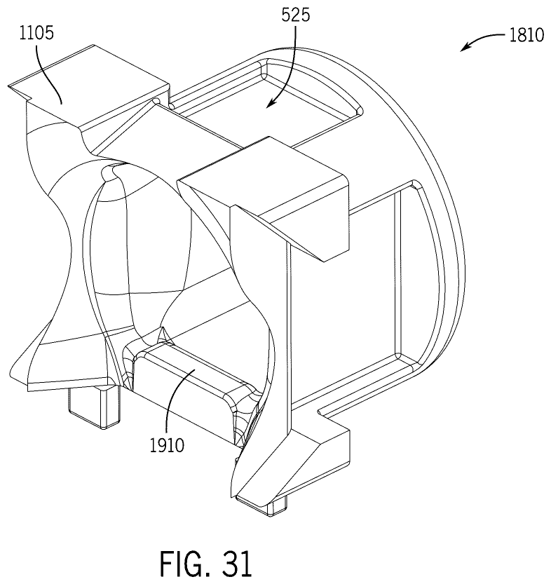

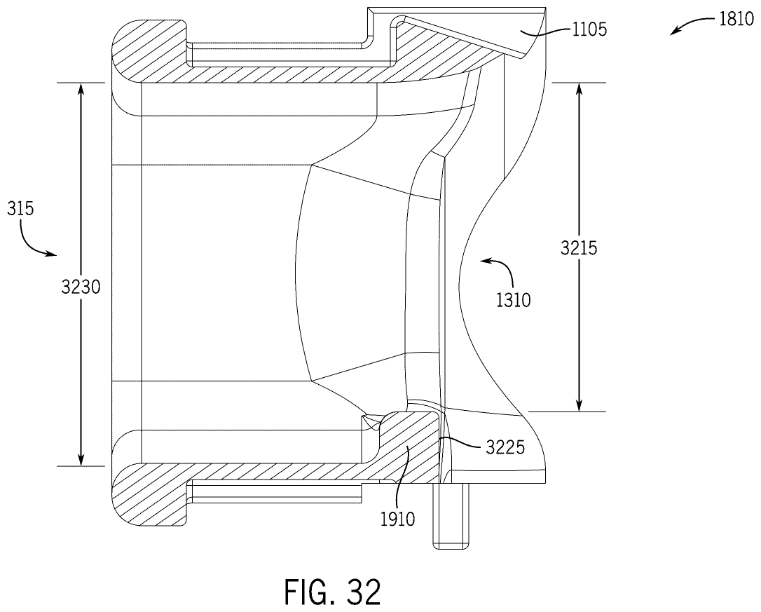

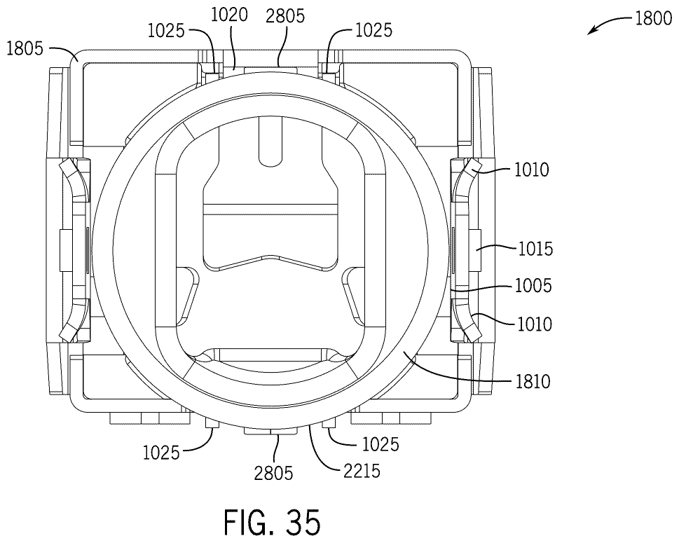

FIGS. 18-36 illustrate another example of a cable connector 1800. As will be recognized, the cable connector 1800 shares a number of components in common with and operates in a similar fashion to the examples illustrated and described previously (e.g., the cable connector 100). For the sake of brevity, these common features will not be again described below in detail. Rather, previous discussion of commonly named or numbered features, unless otherwise indicated, also applies to example configurations of the cable connector 1800.

FIGS. 18-21 illustrate an example of a connector 1800 for retaining a cable (e.g., a metal clad cable, armor clad cable, wire, etc.). In one example, the connector 1800 may include a housing 1805 (e.g., integrally formed) that receives an insert 1810 (e.g., integrally formed, separately from the housing 1805). In one example, the housing 1805 may define a rectangular cross-sectional or perimeter shape, while the insert 1810 may define a circular cross-sectional or perimeter shape, at least at one end thereof. For example, the insert 1810 may define a circular shape to permit a user to secure the connector 1800 within a circular knockout of a junction box or other mounting location, whereas the housing 1805 may define a rectangular shape for improved manufacturability and overall assembly performance. As should be appreciated, the dimensions of the insert 1810—and the connector 1800 generally—may be sized match a particular size knockout on the junction box (e.g., a ½ inch knockout, ¾ inch knockout, etc.). In other examples, the housing 1805 may define other shapes other than rectangular (e.g., circular, polygonal, etc.). In one particular example, the housing 1805 may be made from a metal material, while the insert 1810 may be made from a plastic or other polymeric material.

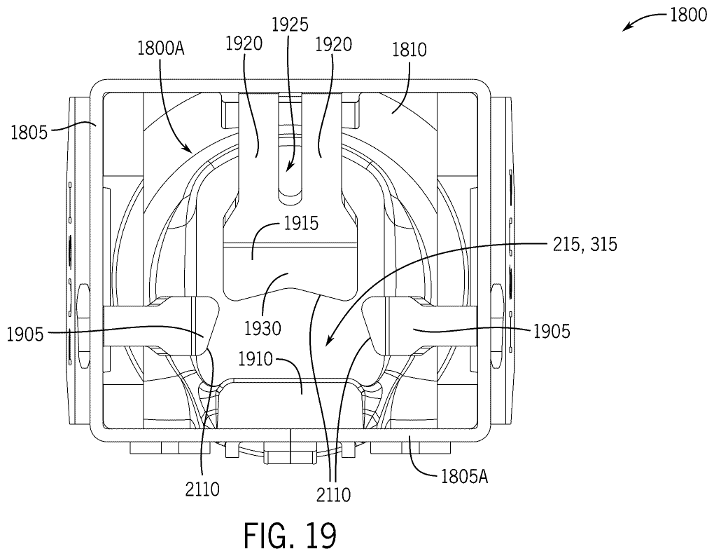

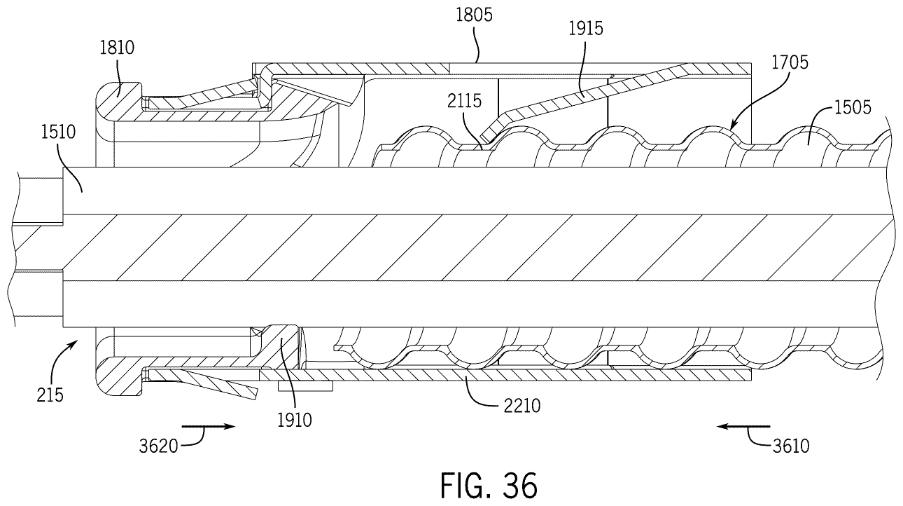

Referring to FIG. 19 in particular, the connector 1800 may be configured to receive and retain a cable within an internal passage 1800A through the connector 1800. In one particular example, the connector 1800 may be configured to retain armor clad or metal clad cable having an exterior sheath surrounding one or more interior conductors (e.g., wires). In one particular example, the exterior sheath of the cable may define a series of spiral grooves around the exterior circumference of the cable (see, e.g., FIG. 36).

To secure the cable within the passage through the connector 1800, the housing 1805 may include one or more fingers 1905, 1915 that can be arranged with offset spacing around a perimeter of the internal passage 1800A of the connector 1800. Thus, for example, the fingers 1905, 1915 can partly define an opening 215 for a cable, with the opening 215 defining a reduced cross-sectional area relative to the full passage through the connector 1800 as viewed along an insertion direction through the internal passage 1800A (e.g., into the page in FIG. 19). In some examples, as shown in FIG. 19, a side wall 1805A of the housing 1805 may cooperate with the fingers 1905, 1915 to further define the opening 215 (e.g., with no finger being formed from the wall 1805A). Generally, the fingers 1905, 1915 may be biased towards engagement with the cable to secure the cable within the opening 215. However, the fingers 1905, 1915 may also exhibit sufficient flexibility so that the cable may be inserted into the opening 215 without excessive force or risk of damaging the cable.

In some examples, the connector 1800 may include a set of first fingers 1905, which may extend from opposing sides of the housing 1805. Further, in some examples, to define the opening 215, the fingers 1905 may include angled edges 2015. In some examples, the connector 1800 may further include one or more second fingers 1915, which may extend perpendicular to the first fingers 1905, between the first fingers 1905 to define the opening 215 (e.g., opposite a protrusion 1910 of the insert 1810). Put differently, the opening 215 may be defined between the first fingers 1905, the second finger 1915, and a side wall of the housing 1805. Thus, when the cable is arranged within the opening 215, the cable may be secured within the opening, by the first fingers 1905, the second finger 1915, and a side wall of the housing 1805. To further improve retentive engagement and reduce the risk of damage to the cable, the second finger 1915 may include an edge 2005 defining a butterfly type shape, without sharp edges or corners.

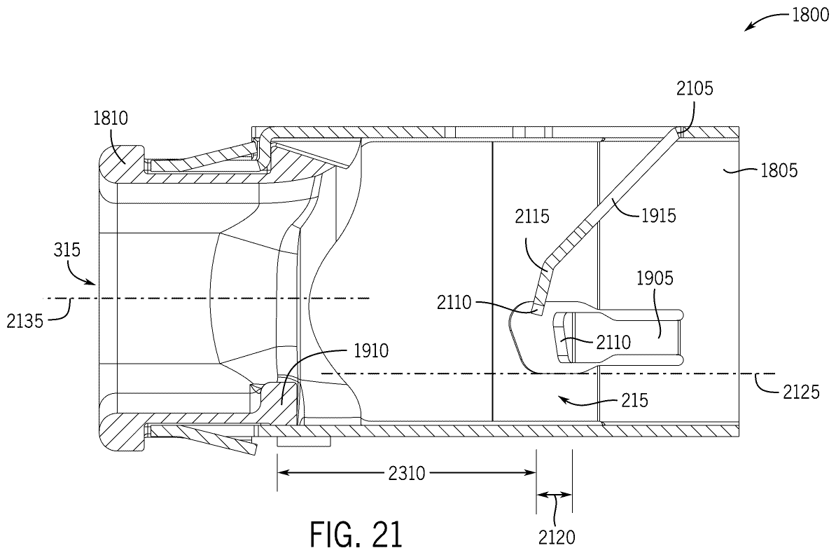

Referring in particular to FIG. 21, the fingers 1905, 1915 may have, respectively, a first end 2105 secured to the housing 1805 and may extend from the first end 2105 away from the housing 1805 at an acute angle toward a second end 2110. In one example, the second end 2110 may define an angled portion 2115 to further support appropriate positioning and engagement of the second end 2110 within the groove of the exterior sheath of a cable (e.g., to “lock” into the groove of the cable). In particular, for example, as viewed along an insertion direction (e.g., into the page in FIG. 19) the second end 2110 may extend obliquely relative to a correspondingly located tangent line of a circumference of a cable cross-section (or reference circle) that is centered within the opening 215. As mentioned previously, the fingers 1905, 1915 may be biased towards the cable so that, when the cable is inserted (axially) into the connector 1800, the fingers 1905, 1915 apply a retention force to the cable.

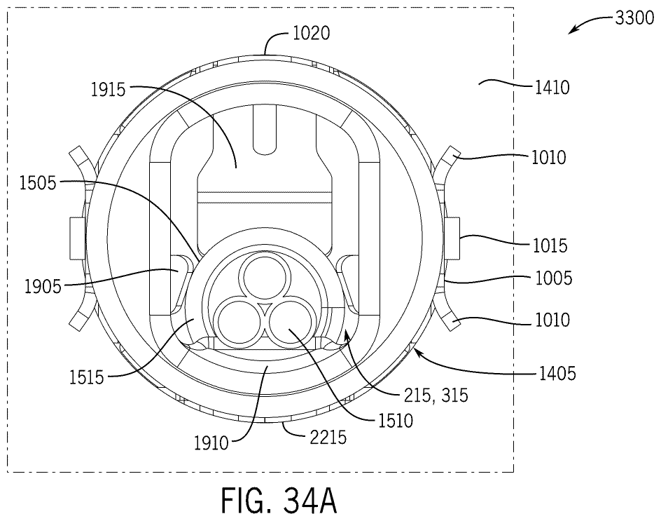

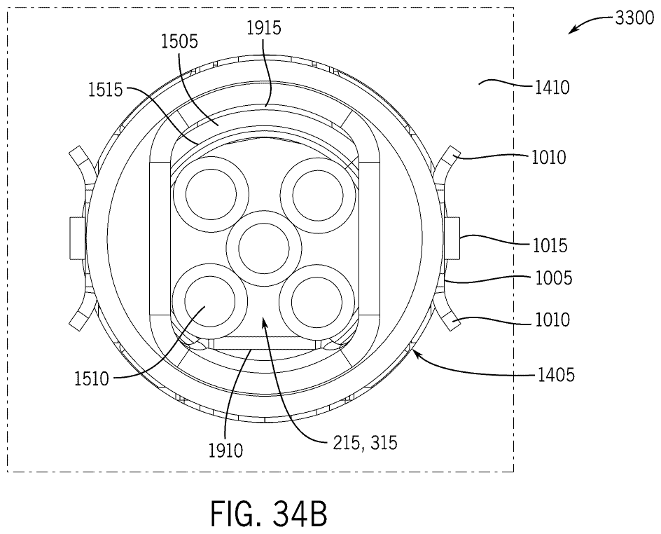

In some examples, the first fingers 1905 may be solid (e.g., unbroken) between the first end 2105 and the second end 2110, while the second finger 1915 may include a pair of arms 1920 separated by a channel 1925. For example, the arms 1920 may extend from the first end 2105 towards the second end 2110 until reaching a head 1930 of the second finger 1915. Thus, a portion of the second finger 1915 may be split via the channel 1925 at a first end, while the head 1930 of the second finger 1915 may be solid at a second end. Thus, flexibility of the second finger 1915 may be maintained, while still providing sufficient rigidity to secure a cable within the opening 215. Further, an engagement width of the second finger 1915 may be larger than (e.g., about double) an engagement width of one of the first fingers 1905, which may provide an increased clamping force to a cable arranged within the housing 1805. As shown in FIG. 19, for example, to engage a cable (see, e.g., FIGS. 34A and 36), free second end 2110 of the first fingers 1905 may extend over an engagement width (e.g., generally vertical, as shown) that is shorter than the engagement width (e.g., generally horizontal, as shown) of the free second end 2110 of the second finger 1915

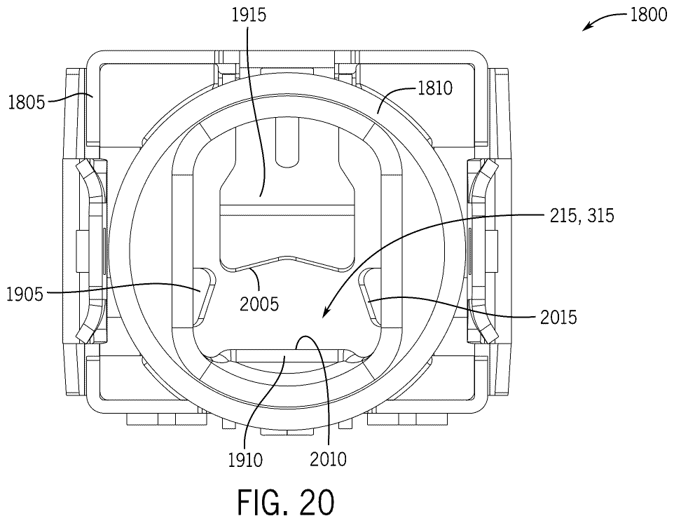

In some examples, the insert 1810 may also define an opening 315 to axially receive a cable. Complementary to the fingers 1905, 1915, the insert 1810 may include one or more protrusions 1910 that can define a reduced cross-sectional area of the opening 315. In this regard, for example, the protrusions 1910 can help to prevent over-insertion of the exterior sheath of the cable, while guiding the conductors of the cable through the connector 1800. The protrusions 1910 may include a rounded inner edge 2010 (see FIG. 20) to reduce the risk of damage to the conductors when the conductors pass through the opening 315 of the connector 1800. In one particular example, the connector 1800 may include only a single protrusion 1910 arranged opposite the second finger 1915 and perpendicular to the first fingers 1905.

In some examples, the opening 215 may facilitate insertion of a cable along an axis 2125 of the housing, which may be offset towards one side of the housing 1805. Correspondingly, the opening 315 of the insert 1810 may facilitate insertion of a cable along an axis 2135 of the insert 1810. In some examples, the openings 215, 315 may each define axes 2125, 2135 extending through the internal passage along the insertion direction. In some cases, the axes 2125, 2135 can be parallel, but offset transverse to the insertion direction. Thus, during insertion of the cable, the cable may be bent between the insert 1810 and the housing 1805 (e.g., along the axes 2125, 2135), which may increase the pulling force required to remove the cable from the cable connector 1800.

In some examples, the fingers 1905, 1915 may offset relative to each other along the axis 2125 (e.g., as shown by offset 2120 in FIG. 21). In some cases, the offset 2120 may correspond to a pitch of a spiral exterior of a cable, so that each of the fingers 1905, 1915 can seat in a trough portion of the spiral. In some examples, a distance 2130 from the protrusion 1910 to one of the fingers 1905, 1915 may be configured to permit at least two spiral grooves of an exterior sheath of the cable to be arranged between the fingers 1905, 1915 and the protrusion 1910. Thus, even if the fingers 1905, 1915 were to slip off of one of the grooves of the exterior sheath of the cable, the fingers may grab or grip another groove of the cable. In another example, the two spiral groove spacing may mitigate the risk of tearing of the exterior sheath of the cable when a pull-out force is applied to the cable.

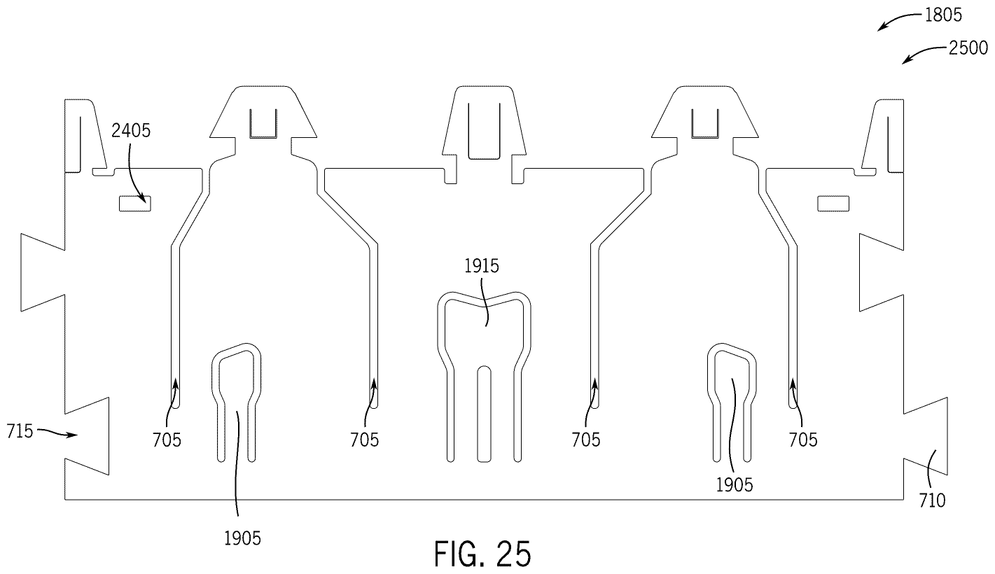

In a particular example, referring also to FIG. 25, base ends of the fingers 1905, 1915 may be formed at similar (e.g., aligned) axial positions along the material of the housing 1805, but the fingers 1905, 1915 may be formed to exhibit different lengths. Accordingly, depending on the angle of extension into the internal passage, free ends of the fingers 1905, 1915 (e.g., at ends 2110, as shown in FIGS. 19 and 21) can be axially offset relative to each other along the internal passage (e.g., to engage with the spiraling material of the exterior of MC cable or other similar surfaces).

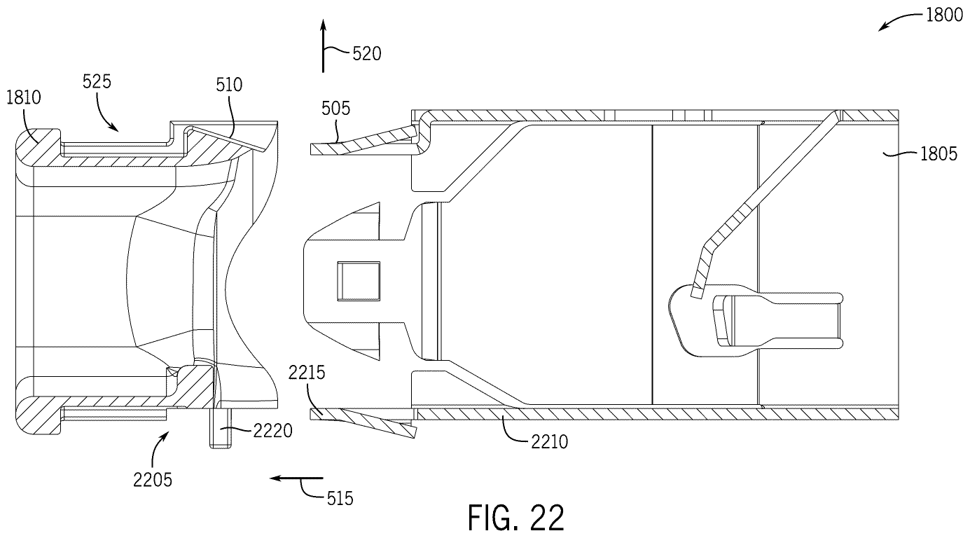

FIGS. 22-24 show an example of a snap-fit assembly method for the connector 1800. For example, to secure the insert 1810 to the housing 1805 (e.g., to form the connector 1800), one or more arms 505, 2215 of the housing 1805 may be aligned with the insert 1810. For example, one or more ramped surfaces 510 of the connector 1800 (e.g., exterior ramped surfaces, as shown) may be aligned with a biased arm 505, which may include a bend configured to lock the arm 505 within a cutout 525 of the insert 1810. Correspondingly, an arm 2215 extending from a first side 2210 (e.g., a first side wall 2210) of the housing 1805 may not include a bend (e.g., may be flush with the side wall 2210). Thus, the arm 2215 may be aligned with a notched portion 2205 of the insert 1810, opposite the cutout 525. In some examples, the cutout 525 may protrude into, but not through, the material of the housing 1805. Accordingly, for example, the housing 1805 may define a closed perimeter surrounding the opening 315 along the insertion direction, and thus also surrounding conductors of a cable that are received along the axis 2135 into the relevant electrical box (see, e.g., FIGS. 21 and 34A)

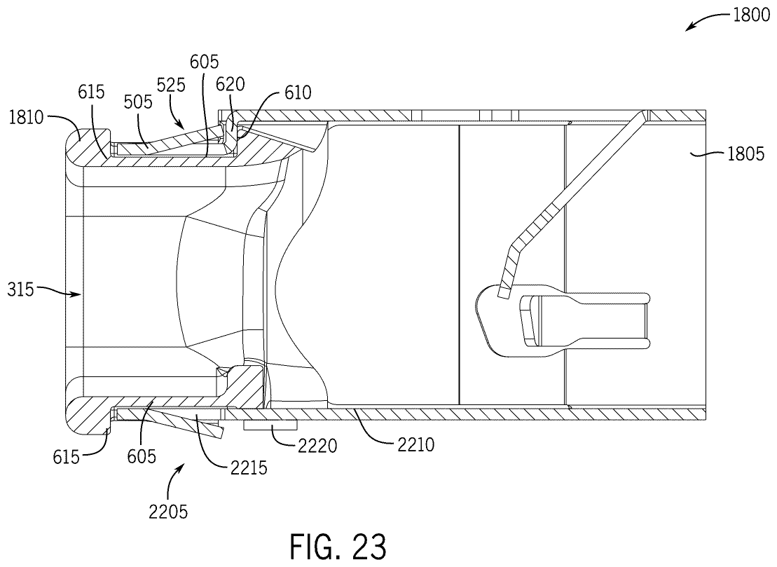

Following this, a user may push the housing 1805 towards the insert 1810 as shown by arrow 515 (or push the housing 1805 towards the insert 1810), to cause the biased arms 505 to deflect outwards along the ramped surface 510 (e.g., in a direction shown by arrow 520). Correspondingly, the arms 2215 may slide within the notched portion 2205. The user may then continue to push the housing 1805 and the insert 1810 together until the arms 505 snap (or otherwise lock) into the cutout 525 defined by the insert 1810 and one or more tabs 2220 extending from the notched portion 2205 of the insert 1810 are arranged within corresponding openings 2405 of the side wall 2210. With this arrangement, as shown in FIG. 23, the insert 1810 can be securely attached to the housing 1805 to provide a guide and stop for cables (as further discussed above and below), without extending internal to the housing 1805 so as to impede insertion of cables of various sizes.

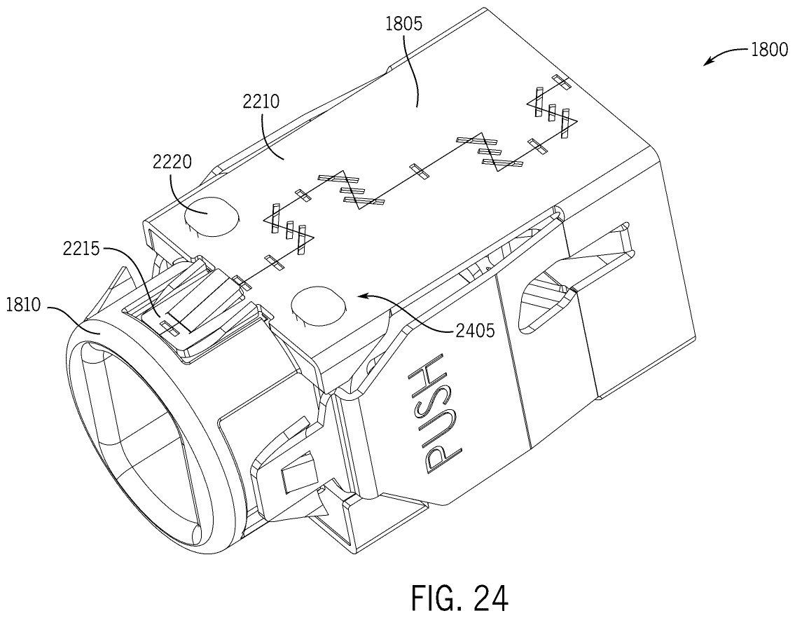

In some examples, the cutout 525 can be defined by a first wall 610 and a second wall 615 with an inner surface 605 extending between the first wall 610 and the second wall 615. Correspondingly, the notched portion 2205 can be defined by the second wall 615 only, without the first wall 610. Thus, when the arms 505 lock into the cutout 525, the arms 505 contact the inner surface 605 so that a base 620 of the arms 505 contacts the first wall 610 of the cutout 525 to prevent removal of the housing 1805 from the insert 1810. Similarly, when the arms 505 lock into the cutout 525, the tabs 2220 may be arranged within the openings 2405 of the first wall 2210 to further prevent removal of the housing 1805 from the insert 1810. Further, the second wall 615 can provide a stop against over-insertion of the insert 1810 into the housing 1805. Thus, for example, the arms 505, 2215 are retained within the cutout 525 and the notched portion 2205 via the first wall 610, the second wall 615, and the tabs 2220, respectively. In one example, after securing the insert 1810 into the housing 1805, the insert 1810 and the housing 1805 form a unitary assembly in the form of the connector 1800 (see, e.g., FIG. 24). In some examples, to further prevent removal of the insert 1810 from the housing 1805, the tabs 2220 may be partly melted (e.g., heat staked so that the tabs 2220 mushroom), which may prevent removal of the tabs 2220 through the openings 2405.

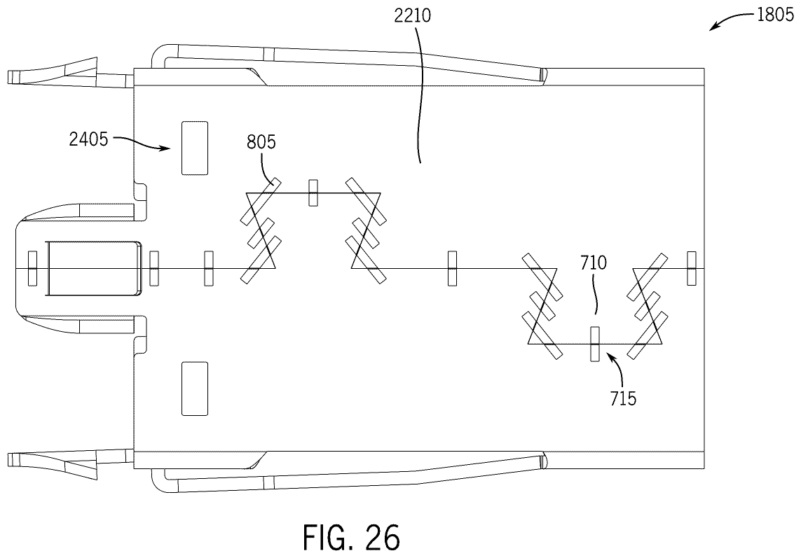

An assembly process for the housing 1805 will be discussed with respect to FIGS. 25 and 26, for example, the housing 1805 may begin as a blank of metal, blank 2500 (e.g., spring steel having a thickness of about.031 inch). In an initial (e.g., initially stamped) form, as shown in FIG. 25, the blank 2500 may include a series of slots 705 corresponding to bend locations at which the blank 2500 can be bent to form the final shape of the housing 1805. Further, the openings 2405 (e.g., to receive the tabs 2220) may be pre-stamped into the blank 2500. In one example, once the blank 2500 is bent to form the housing 1805 shape, one or more dovetail protrusions 710 may be located within one or more dovetail slots 715.

In one example, prior to bending the blank 2500 into a rectangular or other final shape for the housing 1805, the fingers 1905, 1915 are first bent away from the blank 2500. Once the blank 700 has been folded along the slots 705 to form the shape of the housing 1805, prior to heat treating the housing 1805, the operator may stake 805 the connections between the dovetail protrusions 710 and the dovetail slots 715. In one example, once the dovetail protrusions 710 and the dovetail slots 715 are staked 805 together, the housing 1805 may undergo a heat treat process to harden the housing 1805.

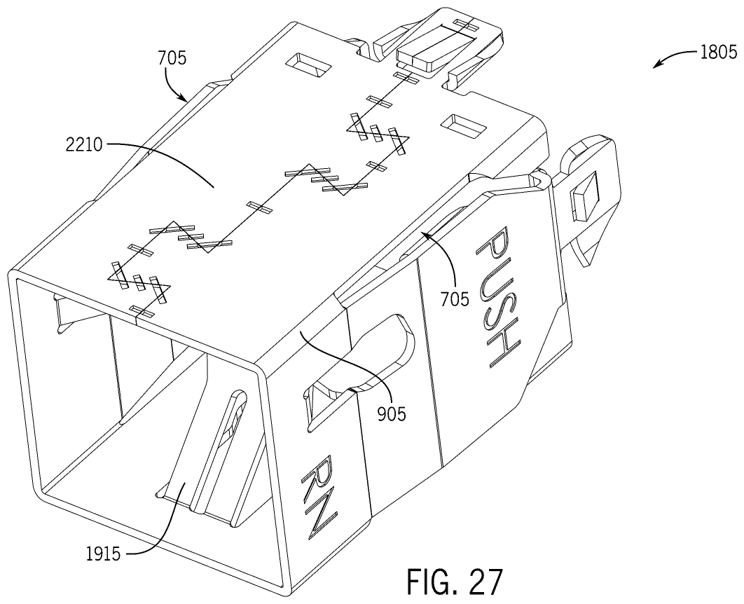

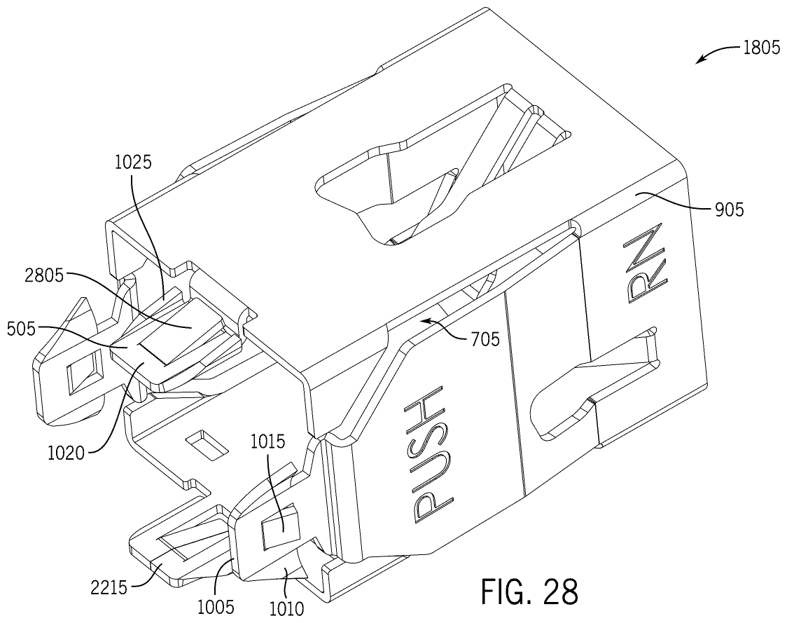

Looking now at FIGS. 27 and 28, the assembled housing 1805 is shown. As mentioned previously, the housing 1805 includes slots 705 at each of the corners or bends 905 of the housing 1805. Thus, each side of the housing 1805 may be at least partially cantilevered, and correspondingly flexible to permit some deflection in the sides of the housing 1805. For example, the sides of the housing 1805 may be deflected during insertion of one or more locking tabs 1005 into a knockout of a mounting location (as further discussed below).

In one example, referring in particular to FIG. 28, the locking tabs 1005 may include a pair of wings 1010 and a locking protrusion 1015 (e.g., centered or otherwise between the wings 1010) configured to engage the knockout to secure the connector 1800 within the knockout (e.g., via snap or interference fit). The housing 1805 may further include one or more retention tabs 1020 configured to further secure the housing 1805 within the knockout (e.g., in the illustrated example, formed on the arms 505, 2215). For example, the retention tabs 1020 may include an angled surface 1025 and a wedge 2805 (e.g., centered or otherwise between the angled surfaces 1025) configured to secure the connector 1800 within the knockout. In one example, the angled surfaces 1025 and the wedge 2805 may permit a user to secure the connector 1800 within knockouts of having slight variations from standard opening sizes, with corresponding improvements in prevention of wobble between the connector 1800 and the junction box or other mounting location. In one particular example, the locking tabs 1005 may be arranged on two (2) sides of the housing 1805, opposite each other. Correspondingly, the retention tabs 1020 may be arranged on two (2) sides of the housing 1805, opposite each other.

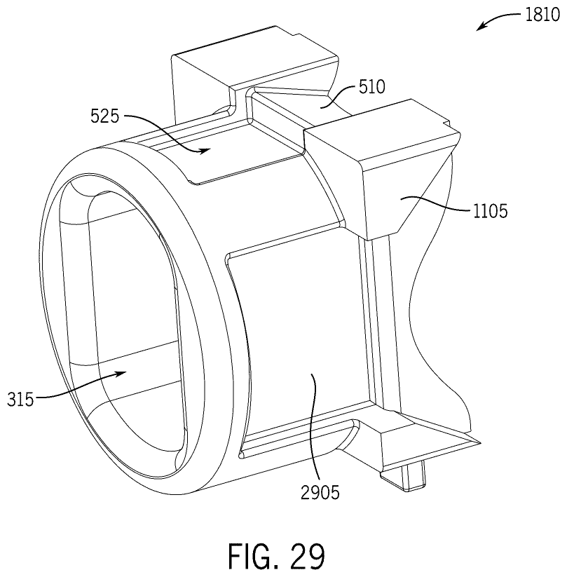

FIGS. 29-32 show an example of the insert 1810 of the connector 1800. In one example, the insert 1810 may include a base 1105 and a flange 1110 extending away from the base 1105. The base 1105 may define a substantially rectangular shape to permit the insert 1810 to fit within the housing 1805. Put differently, the shape of the base 1105 may correspond to the shape of the housing 1805. In one example, an exterior surface of the flange 1110 may define a substantially cylindrical shape to permit the insert 1810 to fit within the knockout of the junction box or other mounting location. As mentioned previously, the flange 1110 may be sized to correspond to (e.g., have a diameter approximately equal to) a predetermined knockout size (e.g., ½ inch, ¾ inch, etc.).

In one example, the protrusion 1910 may be arranged at a mouth 1310 of the insert 1810. Further, the protrusion 1910 may include a flat portion 3225 configured to provide a stop for the exterior sheath of a cable (e.g., during insertion of the cable). Thus, the mouth 1310 may define a height 3215 that is smaller than a corresponding diameter 3230 of the opening 315. For example, the opening 315 may define an oval or other oblong (e.g., other non-circular) shape to permit a user to insert a variety of sizes of cable (e.g., excluding the exterior sheath) through the opening 315. Thus, the connector 1800 may be usable with a variety of cable sizes. In other words, the mouth 1310 can provide a relatively smaller diameter (e.g., via the protrusion 1910) to receive a cable into the insert 1810, while preventing the cable sheath from passing into the opening 315. Correspondingly, the oblong shape of the opening 315 may provide a relatively larger diameter to permit the passage of conductors of the cable through the insert 1810.

In some examples, unlike the insert 110, the insert 1810 may include solid side walls 2905, which may mitigate the risk of an operator pushing the locking tabs 1005 into contact with one or more conductors of the cable (e.g., within the insert 1810).

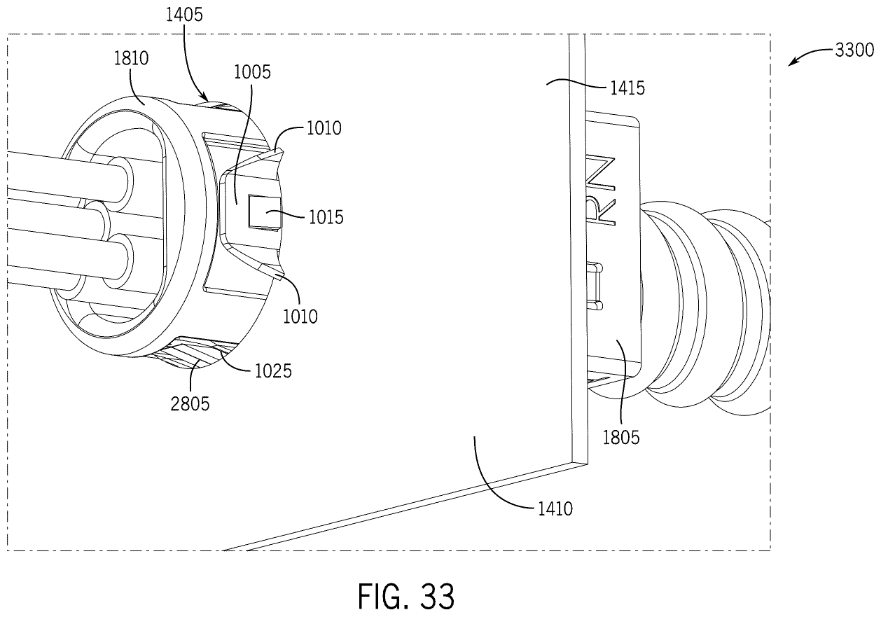

FIGS. 33-36 show examples of a cable connection assembly 3300 with the connector 1800 secured within a knockout 1405 of a mounting location 1410 (e.g., a wall of a junction box) and with a cable 1505 (e.g., a metal clad or armor clad cable) arranged within the openings 215, 315 of the connector 1800 (see FIGS. 34A and 34B in particular). In one example, the wings 1010 and the locking protrusion 1015 of the locking tabs 1005 may protrude through the knockout 1405 and engage the surface 1415 of the mounting location 1410 to prevent removal of the connector 1800 from the mounting location 1410. Further, to tighten the connection between the connector 1800 and the knockout 1405 (e.g., take-up tolerance between the connector 1800 and the knockout 1405) the angled surface 1025 and the wedge 2805 of the retention tabs 1020 may further secure the connector 1800 into the knockout 1405. Thus, the further the connector 1800 is pushed into the knockout 1405 the more strongly the tabs 1020 will engage the surrounding material, due to the angled surface 1025 and the wedge 2805 of the retention tabs 1020. In one example, when the connector 1800 is inserted into the knockout 1405, the connector 1800 may have twelve (12) points of contact between the connector 1800 and the surface 1415 of the mounting location 1410 to mitigate wobble between the connector and the knockout (e.g., via the retention tabs 1020 and the locking tabs 1005, collectively).

In one example, once the connector 1800 is secured within the knockout 1405, the cable 1505 may be inserted into the connector 1800. In other examples, the cable 1505 may be inserted into the connector 1800 prior to the insertion of the connector 1800 into the knockout 1405. As shown, the cable 1505 may include an exterior sheath 1515 (e.g., metal or armor cladding), which defines a spiral groove 1705. In one example, the cable 1505 may include one or more conductors 1510 (e.g., insulated wires) arranged within the exterior sheath 1515 (see, e.g., FIGS. 34A and 34B in particular). As discussed previously, the fingers 1905, 1915 may lock within the spiral groove 1705 of exterior sheath 1515. In one particular example, the angled portion of the fingers 1905, 1915 may be arranged to lock into a corner of the groove 1705 to secure the cable 1505 within the connector 100 (see FIG. 36).

Still referring to FIG. 36, in one example, to insert the cable 1505, the cable 1505 may be pushed into the opening 215 of the connector 1800 in the direction shown by arrow 3610 (e.g., along the wall 2210 of the housing 1805). The resulting movement of the cable 1505 can deflect the fingers 1905, 1915 away from the exterior sheath 1515, until a front edge of the exterior sheath 1515 contacts the flat portion 3225 of the protrusion 1910. In one example, based on the overall size (e.g., diameter) of the exterior sheath, the exterior sheath 1515 may deflect the second finger 1915 different amount (see, e.g., FIGS. 34A and 34B). Put differently, the exterior sheath 1515 may take up a larger amount of the opening 215 for a larger cable size (see, e.g., FIG. 34B) and may take up a smaller amount of the opening 215 for a smaller cable size (see, e.g., FIG. 34A).

Once the exterior sheath 1515 contacts the protrusion 1910, the one or more fingers 1905, 1915 may engage with the groove 1705 of the exterior sheath 1515 to lock the cable 1505 within the connector 1800. Correspondingly, the cable 1505 may be prevented from movement in the direction shown by arrow 3620 (e.g., via the fingers 1905, 1915). Further, due to the difference in size between the exterior sheath 1515 and the conductors 1510, the exterior sheath 1515 may be prevented from protruding through the opening 315 via the protrusion 1910 while the conductors 1510 can protrude through the opening 315 into the junction box or other location (e.g., through the knockout 1405 as shown in FIG. 33).

Further, as the exterior sheath 1515 of the cable 1505 is clamped against the side wall 2210 of the housing 1805, the amount of current able to pass through the conductors 1510 may be higher, without corresponding damage to the connector 1800 (e.g., due to contact between the cable 1505 and the side wall 2210 of the housing 1805). Additionally, due to the solid head 1930 of the second finger 1915, combined with the angled ends of the first fingers 1905, removal of the cable 1505 may be facilitated. For example, a user may rotate the cable 1505 (e.g., in a counterclockwise direction) to “unscrew” the cable from the connector 1800. Thus, the fingers 1905, 1915 may “unscrew” from the groove 1705 of the exterior sheath 1515 to permit removal of the cable 1505. Further, due to the split arm 1920 design of the second finger 1915, the amount of force required to insert the cable 1505 into the opening 215 may be reduced vs. solid arm designs.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within +12 degrees of a reference direction (e.g., within +6 degrees), inclusive.

Also as used herein, unless otherwise limited or defined, “substantially perpendicular” indicates a direction that is within +12 degrees of perpendicular a reference direction (e.g., within +6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Also as used herein in the context of cable connectors, unless otherwise limited or defined, “axial” and derivatives refer to an axial direction of an elongate cable that is received into (e.g., fully through) the relevant connector. Thus, for example, with a cylindrical cable received through a housing and insert of a cable connector, an axial direction is a direction along a centerline of the cable within the housing and insert. Correspondingly, unless otherwise limited or defined, “radial” indicates a direction perpendicular to axial, and the terms “inward” and “outward” indicate movement transverse to axial, toward and away from a reference centerline, respectively.

Additionally, unless otherwise specified or limited, the terms “about” and “approximately,” as used herein with respect to a reference value, refer to variations from the reference value of +25% or less, inclusive of the endpoints of the range. Similarly, the term “substantially equal” (and the like) as used herein with respect to a reference value refers to variations from the reference value of less than +15%, inclusive. Where specified, “substantially” can indicate in particular a variation in one numerical direction relative to a reference value. For example, “substantially less” than a reference value (and the like) indicates a value that is reduced from the reference value by 15% or more, and “substantially more” than a reference value (and the like) indicates a value that is increased from the reference value by 15% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A cable connector, comprising:
a housing that surrounds an internal passage, the housing including first fingers extending away from opposing sides of the housing into the internal passage, and a second finger extending away from an interior surface of the housing into the internal passage, the second finger being offset from the first fingers around a perimeter of the internal passage, the first and second fingers partly defining a first opening along the internal passage, as viewed along an insertion direction for a cable through the internal passage; and
an insert that extends within the housing, the insert including a protrusion extending into the internal passage from an opposite side of the internal passage as the second finger, the insert, including the protrusion, defining a second opening along the internal passage, as viewed along the insertion direction;
the first opening defined by the first fingers and the second finger being axially offset from the second opening defined by the insert, along a longitudinal axis of the cable connector to receive conductors.

2. The cable connector of claim 1, wherein the protrusion of the insert includes a flat portion facing toward at least the second finger to define a flat edge portion of the second opening.

3. The cable connector of claim 1, wherein the first fingers and the second finger extend at acute angles from first ends secured to the housing to second ends to define the first opening.

4. The cable connector of claim 3, wherein the second ends of the first fingers include angled edges and the second end of the second finger includes an edge with at least two protrusions.

5. The cable connector of claim 4, wherein an engagement width of a free end the second finger is about double an engagement width of a free end of one or more of the first fingers.

6. The cable connector of claim 1, wherein a first end of the second finger is secured to the housing with arms, the arms extending to support a head that forms the second end of the second finger and that is oriented to engage a cable received in the internal passage, and wherein the arms are separated by a channel extending from the first end towards the head.

7. The cable connector of claim 1, wherein the insert includes a flange with a circular external cross-section to be received in a knock-out of an electrical box and with a non-circular internal cross-section that defines the second opening.

8. The cable connector of claim 1, wherein the housing includes a set of opposing locking tabs and a set of opposing retention tabs to secure the cable connector at a knockout of an electrical box.

9. The cable connector of claim 8, wherein the locking tabs and the retention tabs protrude to provide at least ten separate points of contact with an interior wall of the electrical box when the cable connector is secured at the knockout.

10. A method of making a cable connector, comprising:
providing a single-piece blank;
bending fingers defined by the blank out of a plane defined by the blank so that the fingers extends at acute angles relative to the plane defined by the piece of material;
arranging a dovetail protrusion within a dovetail slot of the blank by bending the blank along a series of slots formed in the blank to form a housing with an internal passage, the fingers protruding into the internal passage.

11. The method of claim 10, wherein the housing includes first fingers extending into the internal passage from opposing sides the housing, and a second finger extending into the internal passage between the first fingers so that the first and second fingers collectively a first opening.

12. The method of claim 11, further comprising:
providing an insert including a protrusion within an opening at a first end of the insert; and
securing the insert to the housing via a snap-fit connection so that the protrusion is aligned on an opposite of the internal passage from the second finger of the housing.

13. The method of claim 11, further comprising:
forming the second finger from the blank with arms that extend toward a head to engage a cable, with the arms separated by a channel that extends to the head.

14. The method of claim 12, wherein the insert includes a flange at a second end of the insert, the flange defining a circular external cross-section and an ovular internal cross-section that forms a second opening of the connector.

15. The method of claim 10, further comprising:
forming the housing to include a set of opposing locking tabs and a set of opposing retention tabs, each of the locking tabs of the set including at least two wings arranged to separately engage an inner wall of a junction box at a knockout of the junction box, and each of the retention tabs of the set including at least two angled surfaces arranged to separately engage an edge wall of the knockout.

16. A cable connector, comprising:
a housing that defines an internal passage with an insertion direction for installing a cable through the internal passage, the housing integrally including:
side walls that surround the internal passage along the insertion direction; and
a set of fingers including first fingers and a second finger extending resiliently into the internal passage to define, in cooperation with a side wall of the housing, a first opening to receive and capture cable within the internal passage; and
an insert secured to the housing and protruding into the internal passage to define a second opening, axially offset from the first opening,
the housing having an installed configuration in which the housing is secured at a knockout of a junction box, the cable is secured within the first opening by the set of fingers and the side wall, and the cable extends through the second opening insert into the junction box.

17. The cable connector of claim 16, wherein the second finger of the set of fingers is arranged to bias the cable into a side wall of the housing to provide grounding contact between the cable and the housing.

18. The cable connector of claim 17, wherein the insert includes a protrusion that protrudes, relative to the side wall, into the internal passage to provide a stop against over-insertion of the cable along the insertion direction.

19. The cable connector of claim 16, wherein the first opening defines a first axis along the insertion direction, the second opening defines a second axis along the insertion direction, and the first axis is offset from the second axis.

20. The cable connector of claim 16, wherein the housing includes a set of opposing locking tabs and a set of opposing retention tabs that together provide at least ten points of contact for a junction box knockout location.
